(19) United States
(12) Patent Application Publication
(10) Pub. No.: US 2007/0173087 A1
(43) Pub. Date: Jul. 26, 2007

(54) Electronic component covering plate structure

(75) Inventors: Shu-Yun Chang, Hukou Township (TW); Wen-Yau Liang, Hukou Township (TW)

Correspondence Address: TROXELL LAW OFFICE PLLC;SUITE 1404, 5205 LEESBURG PIKE, FALLS CHURCH, VA, 22041, US

(73) Assignee: Singatron Enterprise Co., Ltd.

(21) Appl. No.: 11/335,672

(22) Filed: Jan. 20, 2006

(51) Int. Cl. H01R 13/44

(52) U.S. Cl. 439/135

(57) ABSTRACT

The present invention includes a connecting device and a covering plate, wherein the covering plate is disposed on a top surface of the connecting device. When stop pieces located on the covering plate are made to slide into clasp grooves of the connecting device, clasp holes in the stop pieces clasp onto protruding shafts located in the clasp grooves. Moreover, a position fixing piece located on one side of the covering plate abuts against an edge of the clasp groove, thereby achieving a tight joining configuration between the covering plate and the connecting device that prevents the covering plate from coming loose and sliding out of position. Furthermore, a clamp hook piece extending from an end of the stop piece is used to clamp onto a bottom portion of the connecting device, thereby preventing signal interference when the connecting device is in contact with a device.

### BACKGROUND OF THE INVENTION

(a) Field of the Invention

The present invention relates to an improved structure of an electronic component covering plate.

(b) Description of the Prior Art

Referring to FIGS. 1 and 2, which show a prior art covering plate A joined to a connecting device B. An external machine is used to crook an end of a stop piece A1 after sliding the stop piece A1 into a clasp groove B1, thereby forming a clip hook A2 on the end of the stop piece A1 that clips onto a bottom portion of the connecting device B. However, effectiveness of the joining structure between the covering plate A and the connecting device B is poor and easily results in the covering plate A becoming loose and sliding out of position.

Hence, the present invention herein discloses a new and improved configuration to resolve and surmount existent technical difficulties to eliminate the aforementioned shortcomings.

### SUMMARY OF THE INVENTION

The present invention relates to an improved structure of an electronic component covering plate, and more particularly to a structure that enables easy assembly and provides firmer joining of a covering plate to a connecting device.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

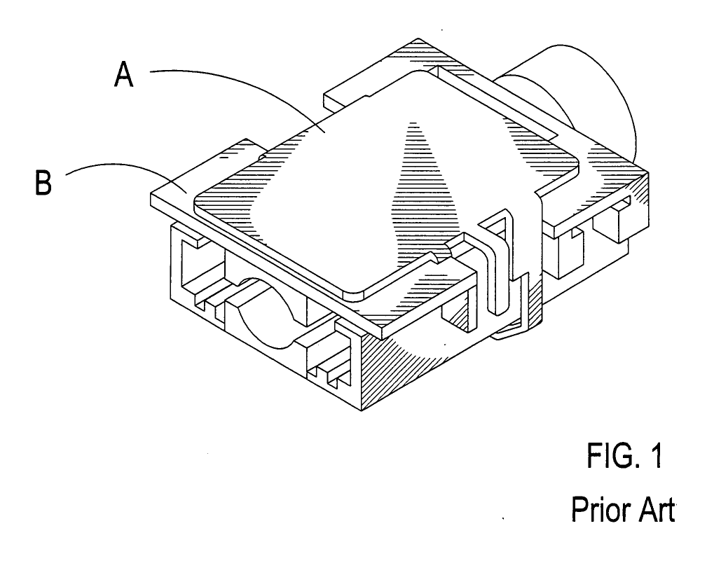

FIG. 2 shows an exploded elevational view of prior art.

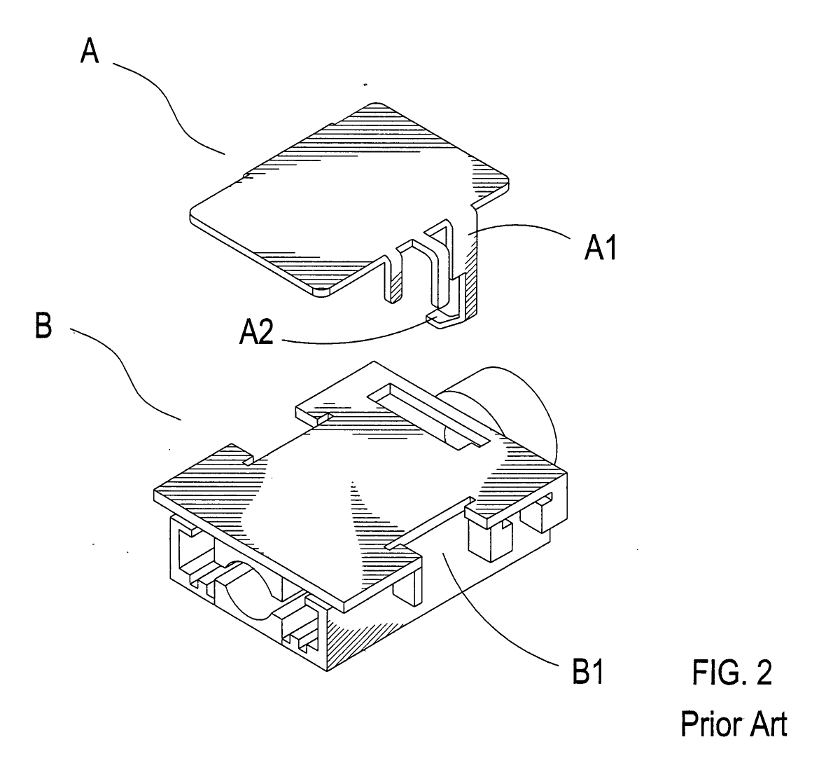

FIG. 3 shows an elevational view according to the present invention.

FIG. 4 shows an exploded elevational view according to the present invention.

FIG. 5 shows a partial schematic view of the present invention.

FIG. 6 shows a first schematic view of the present invention being joined together.

FIG. 7 shows a second schematic view of the present invention being joined together.

FIG. 8 shows a third schematic view of the present invention being joined together.

### DETAILED DESCRIPTION OF THE PREFERRED EMBODIMENTS

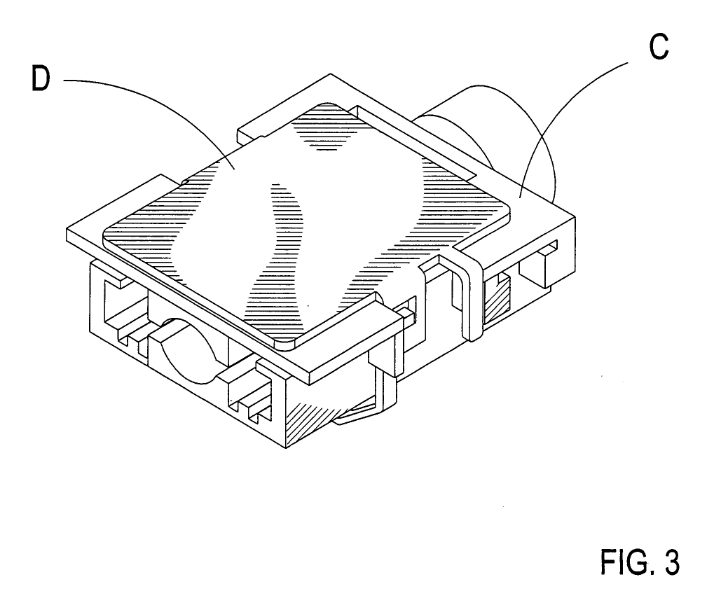

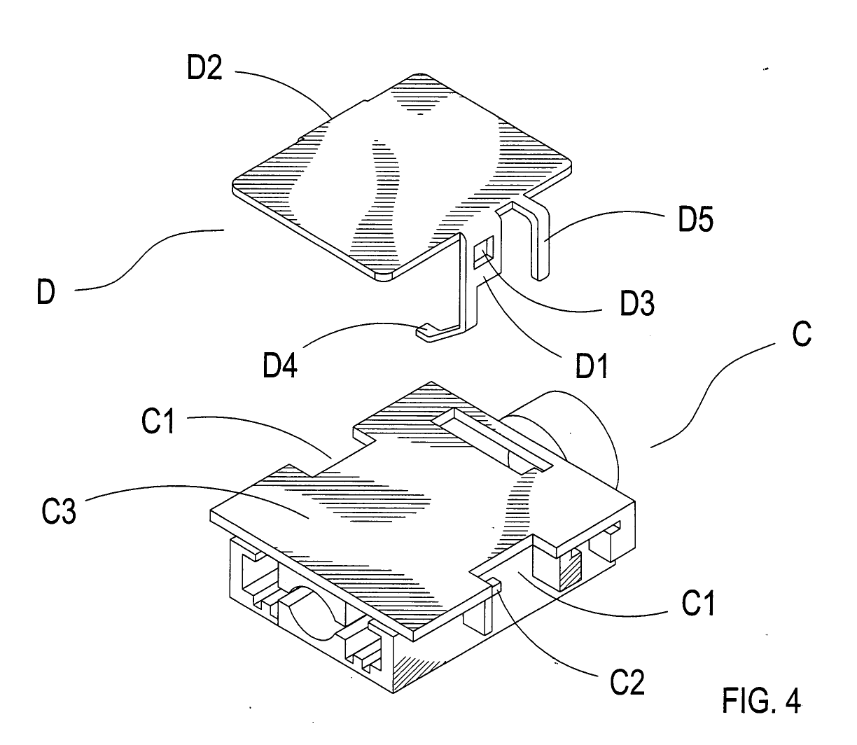

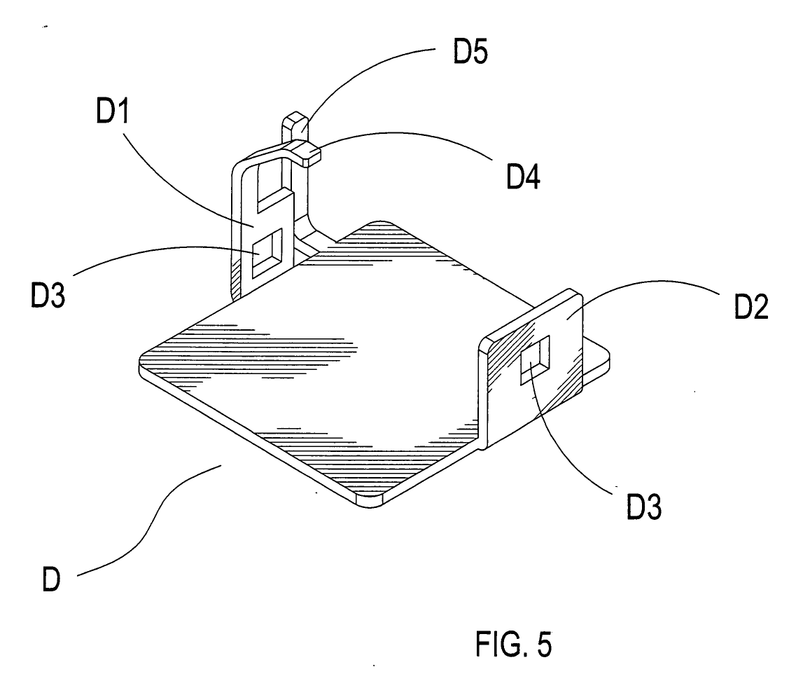

Referring to FIGS. 3, 4 and 5, which show an improved structure of an electronic component covering plate comprising a connecting device C and a covering plate D.

Clasp grooves C1 are defined on symmetric sides of the connecting device C, and a protruding shaft C2 is located within each of the clasp grooves C1. The covering plate D is installed on a top surface C3 of the connecting device C. Stop pieces D1, D2 extend and bend down from symmetric sides of the covering plate D, and disposition of the stop pieces D1, D2 correspond to the clasp grooves C1. Moreover, a clasp hole D3 is defined in each of the stop pieces D1, D2, which enable the protruding shafts C2 to respectively clasp therein. A clamp hook piece D4 extends from an end of the stop piece D1, and clamps onto the connecting device C. A position fixing piece D5 is located beside the stop piece D1 of one side of the covering plate D.

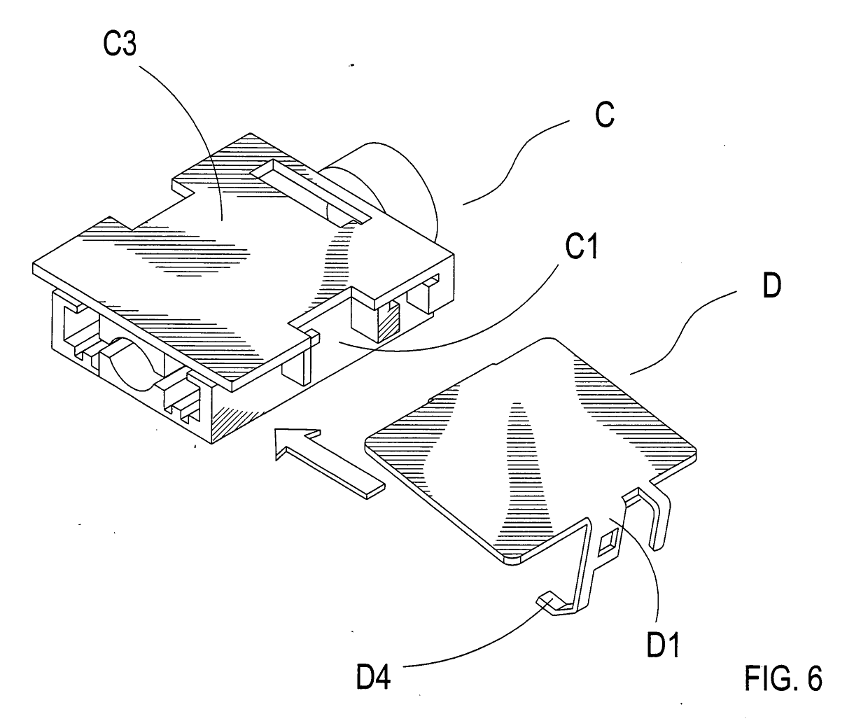

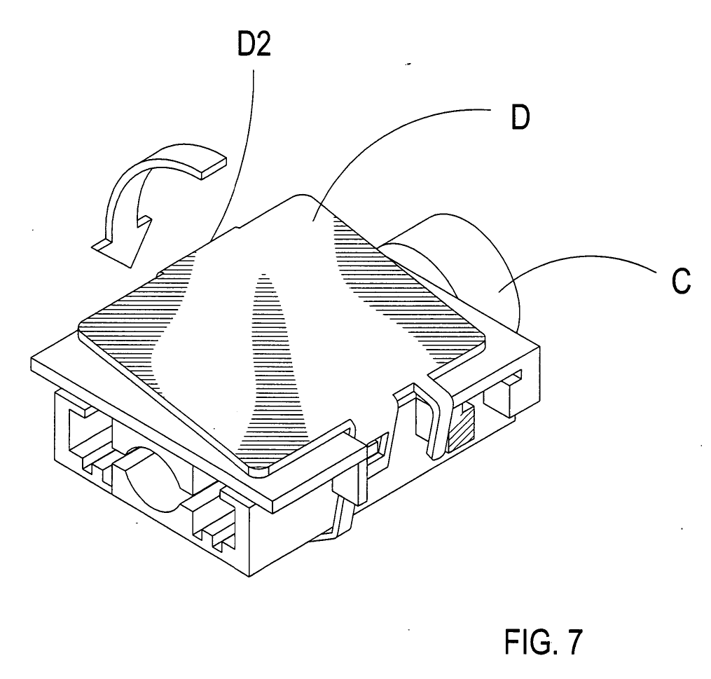

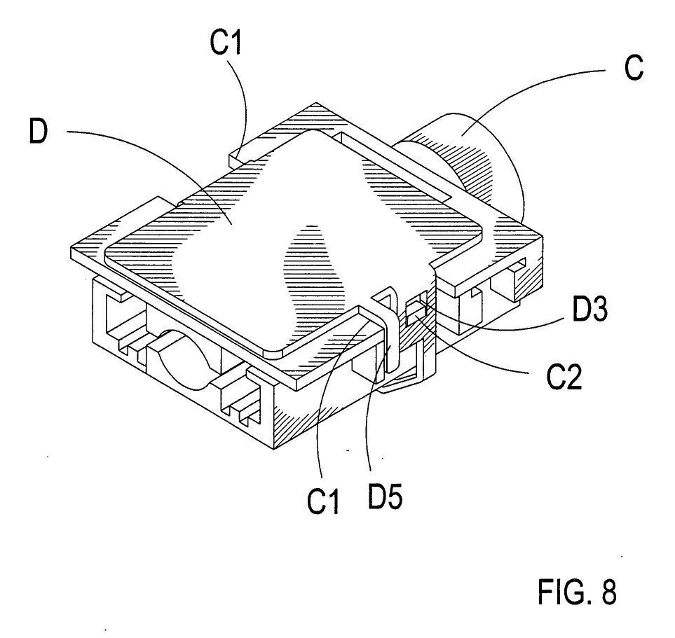

Referring to FIGS. 6, 7 and 8, which show an embodiment of the improved structure of an electronic component covering plate of the present invention wherein the covering plate D is being joined to the top surface C3 of the connecting device C by moving the end of the covering plate D provided with the clamp hook piece D4 of the stop piece D1 towards the clasp groove C1 of one side of the connecting device C at an inclined angle, and when the stop piece D1 is disposed within the clasp groove C1, then the stop piece D2 of the other side of the covering plate D is pressed down into the clasp groove C1 of the other side of the connecting device C, thereby enabling the symmetric clasp shafts C2 to respectively clasp into the symmetric clasp holes D3 and facilitate a tight fitting of the covering plate D on the connecting device C.

The position fixing piece D5 located on one side of the covering plate D fastens down the covering plate D on the connecting device C by means of the position fixing piece D5 abutting against an edge of the clasp groove C1, thereby facilitating joining together the, covering plate D and the connecting device C, and preventing the covering plate D from coming loose and sliding out of position.

In order to better explicitly disclose advancement and practicability of the present invention, a comparison with prior art is described hereinafter:

Shortcomings of Prior Art

1. Easily comes loose and slides out of position.

2. Awkward joining configuration.

Advantages of the Present Invention

1. Prevents the assembled configuration from coming loose.

2. Convenient to assemble.

3. Provided with a tight joining configuration that does not easily come apart.

4. Provided with advancement and practicability.

5. Enhances commercial competitiveness.

In conclusion, the present invention in overcoming structural, shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electronic component covering plate structure comprising a connecting device and a covering plate, wherein clasp grooves are defined on symmetric sides of the connecting device, and the covering plate is installed on a top surface of the connecting device; stop pieces extend from symmetric sides of the covering plate; the electronic component covering plate structure is characterized in that: a clasp hole is defined in each of the stop pieces, and protruding shafts respectively located within clasp grooves enable the clasp holes of the stop pieces to clasp thereon when the covering plate is being fastened to the connecting device, thereby achieving a tight joining between the covering plate and the connecting device.

2. The electronic component covering plate structure according to claim 1, wherein a position fixing piece located beside the stop piece extends and bends down from the covering plate, which enables fixing position of the covering plate on the connecting device, thereby preventing the covering plate from sliding horizontally.

3. The electronic component covering plate structure according to claim 1, wherein a clamp hook piece extends from an end of the stop piece of the covering plate, the clamp hook piece prevents signal interference when the connecting device is in contact with a device.
